(19) United States
(12) Patent Application Publication
(10) Pub. No.: US 2023/0409743 A1
(43) Pub. Date: Dec. 21, 2023

(54) Methods And Systems For Obtaining, Controlling And Viewing User Data

(71) Applicant: DataEarn, Inc., New York, NY (US)

(72) Inventors: Noah G Fennell, New York, NY (US); Otis Moore Scott, New York, NY (US); Angello Michael Lazar, Duluth, GA (US)

(21) Appl. No.: 18/310,007

(22) Filed: May 1, 2023

Related U.S. Application Data
(60) Provisional application No. 63/336,447, filed on Apr. 29, 2022.

(51) Int. Cl. G06F 21/62; G06F 3/0486; G06F 3/0483; G06Q 30/06

(52) U.S. Cl. CPC G06F 21/6245; G06F 3/0486; G06F 2221/2115; G06Q 30/06; G06F 3/0483

(57) ABSTRACT

The present invention provides methods and systems for individuals to see their online data and show it in aggregate across multiple companies giving them the ability to understand and manage their entire digital footprint. Current users on the internet have little to no idea where their data is and have no ownership of that information. Users now have the ability through our invention to access and control of their data.

### CROSS-REFERENCE TO RELATED APPLICATIONS

This present application claims priority to and the benefit of U.S. Provisional Application No. 63/336,447, “Methods And Systems For Obtaining, Controlling And Viewing User Data” (filed Apr. 29, 2022) the entire contents of which is incorporated by reference herein.

### FIELD OF THE INVENTION

The disclosed invention is in the field of consumer personal data generated via internet-related activities.

### BACKGROUND OF THE INVENTION

Over the last couple of years, there has been more awareness and attention to privacy and security policies related to consumers' personal data. In 2018, a law was passed in the European Union (also including the UK) called General Data Privacy Regulation (GDPR) that entitles consumers to have the legal right to access their data from a company that holds any personally identifiable information (PII). In the advent of this law being passed, this allowed consumers to regain access and help create transparency between company and consumer. Fast forward to 2020, a similar law was passed in California called California Consumer Privacy Act (CCPA). This law was similar in regard to GDPR, however, CCPA allows residents of California to access their PII from companies that hold it. In both of these laws, the consumer has the right to request access to their data and obtain and see how a particular organization is processing and handling their data. Companies are required to send the consumer their data within 30-45 days depending on the legal jurisdiction they are in. Within the U.S., there are many other states that have proposed Data Privacy laws that allow even more people within the United States to be able to access their data. This foreshadows a movement potentially toward mass adoption of these types of laws in the United States on a state and potentially federal level.

Currently, consumers have little to no control over their data or an ability to easily access and understand their data across multiple platforms. When consumers go and request their data it is sent in different formats (ex: CSV, JSON, HTML, pdf). Most individuals in the United States and EU once receiving this data have no idea how to gain insights or understand the thousands of lines of code that are presented in front of them. Accordingly, there needs to be a system that allows users to be able to access their data easily, understand it, and give them the ability to manage, protect, and monetize it.

### SUMMARY OF THE INVENTION

Under GDPR and CCPA companies are required to allow data subject data requests (DSARs). These DSAR webpages exist somewhere within the company's privacy policy page or within the company's main website or via email. Various privacy and security policies may provide data subjects (individuals, organizations, or other entities) with certain rights related to the data subject's personal data that is collected, stored, or otherwise processed by an organization. These rights may include for example:
(1) a right to obtain confirmation of whether a particular organization is processing their personal data;
(2) a right to obtain information about the purpose of the processing (ex: one or more reasons for which the personal data was collected);
(3) a right to obtain information about one or more categories of data being processed (ex: what type of personal data is being collected, stored, processed, etc.);
(4) a right to obtain information about one or more categories of recipients with whom their personal data may be shared with (ex: data shared internally within the organization and externally);
(5) a right to obtain information about a time period for which their personal data will be stored (ex: one or more criteria used to determine that time period); and
(6) a right to obtain a copy of any personal data that is being collected.

Through these laws and regulations, a user can use our product by going and requesting data on our website. Once a user requests data on our website they can upload a folder of information (ex: CSV, JSON, HTML, pdf) that contains all of the PII regarding that user and the platform they've used. Our algorithms process that information and create a DataCard that finds the user's digital identity, digital footprint, user statistics, activity, location history, advertisement history, general user information, internal insights, purchase history, and contact information. Through these methods, we can show this data on a company-by-company basis and in aggregate across all companies and categories. Our methodology allows any user to upload from any company and give them a full overview of their digital footprint and how their data is being used.

Accordingly, the disclosed inventions allow individuals to see their data and display it in aggregate across multiple companies giving users the ability to understand and manage their entire digital footprint. Accordingly, the present invention provides for computer-implemented methods executed by one or more processors for obtaining and viewing user data, the methods comprising: sending, to a system and by a user, a data set comprising personally identifiable information and a plurality of platforms; determining, by the system, characteristics of each platform in the plurality of platforms; parsing, by the system, the data set based on the characteristics of each platform; generating, by the system, a DataCard comprising a digital footprint of a user for each platform; displaying, to the user, the DataCard; and querying the user to interact with the DataCard.

The disclosed inventions also provide systems for obtaining and viewing user data, the system comprising a memory storing processor executable instructions and one or more processors to: send, to a system and by a user, a data set comprising personally identifiable information and a plurality of platforms; determine, by the system, characteristics of each platform in the plurality of platforms; parse, by the system, the data set based on the characteristics of each platform; generate, by the system, a DataCard comprising a digital footprint of a user for each platform; display, to the user, the DataCard; and query the user to interact with the DataCard.

The disclosed inventions also provide systems for allowing a user of any company to upload their data into a system that can parse and reverse engineer companies' data into a personal dashboard for the user.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 illustrates an embodiment of the present invention directed to an overview of systems for obtaining and viewing user data;

FIG. 2 illustrates an embodiment the present invention directed to a User Data Subject Request Dashboard and Portal;

FIG. 3 illustrates an embodiment of the present invention directed to a Data Subject Request Dashboard w/Recommendations Algorithm;

FIG. 4 illustrates an embodiment of the present invention directed to a User Data Subject Request Dashboard (UDSRD);

FIG. 5 illustrates an embodiment of the present invention directed to a User uploading data from a company;

FIG. 6 illustrates an embodiment of the present invention directed to a Universal Parser;

FIG. 7 illustrates an embodiment of the present invention directed to validation of uploaded and parsed user data;

FIG. 8 illustrates an embodiment of the present invention directed to Workflow of Displaying DataCards from Companies;

FIG. 9 illustrates an embodiment of the present invention directed to Displaying DataCards for Individual Companies, how a user can control their user data;

FIG. 10 illustrates an embodiment of the present invention directed to the Display DataCards for Individual Companies;

FIG. 11 illustrates an embodiment of the present invention directed to Workflow of Displaying DataCards from Companies;

FIG. 12 illustrates embodiments of displaying a number of DataEarn DataCards corresponding to data from a variety of companies that the user has uploaded of the present invention;

FIG. 13 illustrates an embodiment of the present invention directed to a User Opting in to DataStore;

FIG. 14 illustrates an embodiment of the present invention directed to a DataStore; and

FIG. 15 is a schematic diagram of a generic computer system.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges includes each and every value within that range.

When ranges are used herein for physical properties, such as molecular weight, or chemical properties, such as chemical formulae, all combinations, and subcombinations of ranges for specific embodiments therein are intended to be included.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

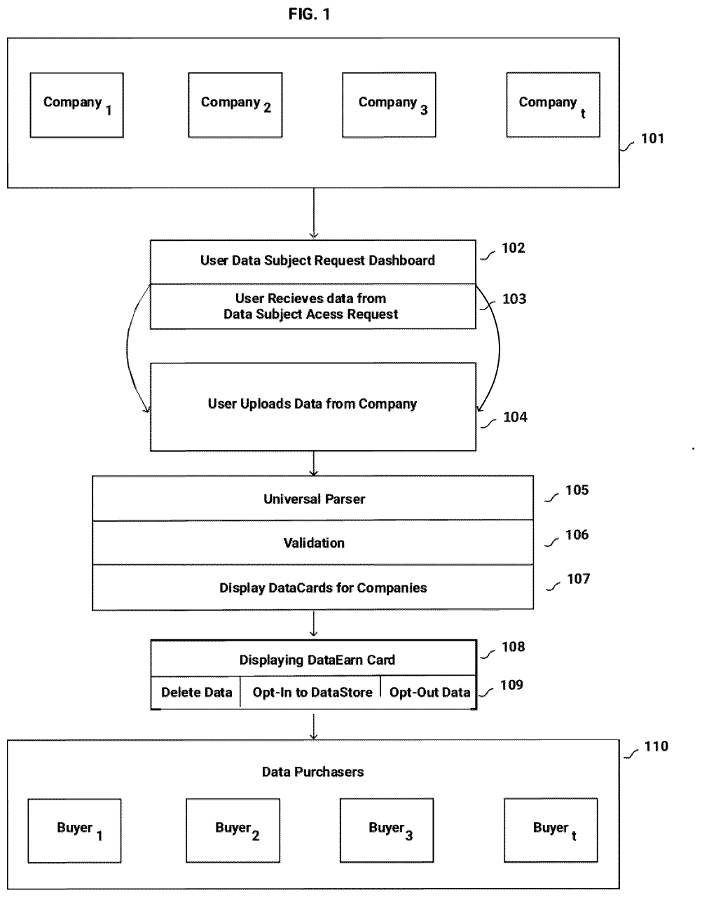

Now referring to FIG. 1: Systems Overview, 101: Users can request data via our User Data Subject Request Dashboard (UDSRD) allows individuals to easily access and request their data from apps or websites all over the internet. 102: Users will be directed to the companies (DSAR) page. Companies DSAR are set up in a variety of ways—email, web forms, and portals. Users are then directed to either login, fill out a form, or confirm their identity for verification on their DSAR. 103: Users will be sent data from the company or companies they have requested data from. The data they have requested will come within minutes from most companies. However, companies legally have to send users their Personally Identifiable Information (PII) within 30 to 45 days depending on their legal jurisdiction and the number of users. Data is typically sent in JSON, HTML, pdf, CSV, excel, and .zip files. Users can download their PII to their desktop or mobile device. 104: Users can drag and drop or select files from their computer that have been received from their DSAR. This upload page allows users the ability to easily upload their PII. 105: This Universal Parser method allows us to add any company into our system and set up a framework that can correctly identify companies, parse through company-specific data, and store data in our database. 106: Once the user has uploaded their data and our algorithms have parsed through the data, there are a variety of ways the system validates the validity of the data. We can validate the data through metadata, timestamps of requests and uploads, data within the file, and edit history. 107: After our systems successfully parsed through the data uploaded by the user, the system can query the users' data in our database and then see their data from the specific companies they've uploaded from. Users can see their data in the form of a DataCard. 108: Once a user uploads data from multiple companies the system can query certain categories of data (off-app activity, location, spending, search, saves, likes, etc) across all companies to show the user their DataEarn Card. The system can show the history of the user's PII and all the data they have produced online across every company the user has ever uploaded onto our website and see a complete digital profile of oneself 109: Users once uploading their data can Opt-Out of companies selling their data, Delete their data from unwanted companies, or Opt-In to the DataStore. Users can click this button that links them to a specific company's Opt-Out of Sale Page. Users can then opt-out of the sale of their data. Users can click this button that will link them to a company's Delete Data Page on a company's website. Users can then delete their data from the desired company. Users can click this button that will link them to a company's Opt-In DataStore Page. Users can then set their preferred price of sale on the data points from the desired company and DataCard. 110: Once you are opt-ed into the DataStore, you can decide to share your data with one or more third parties who will pay you for the right to use your data in ways you permit. In exchange, each buyer will make payments to DataEarn, from which DataEarn will retain a percentage and pass along the remainder of the payment. By submitting data into the DataStore, users can view where their data is going and its value.

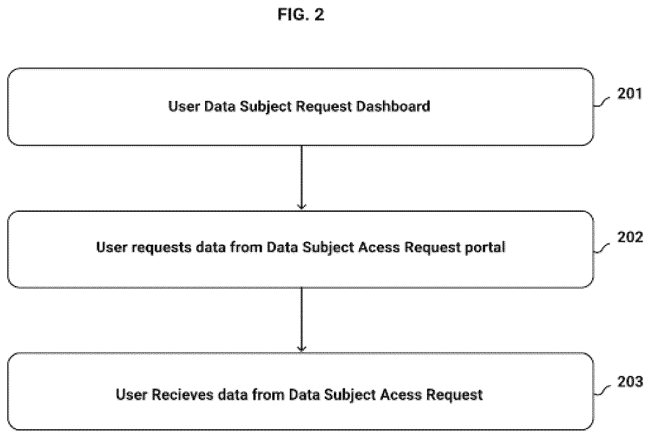

Now referring to FIG. 2: User Data Subject Request Dashboard. 201: The User Data Subject Request Dashboard (UDSRD) allows individuals to easily access and request their data from apps or websites all over the internet. With one click, our UDSRD takes you directly to the company's Subject Data Requests (SDR) page of choice. Users can request data from over 1000+ companies using our dashboard. The UDSRD combines active users worldwide and data within previous upload history to determine what other companies also have access to your digital footprint that you can request from. This allows users to identify where their digital footprint is, where they can request data from, and help improve the validity of the users' data. The Data Subject Access Request (DSAR) portal, 202: Users will be directed to the companies (DSAR) page. Companies DSAR are set up in a variety of ways—email, web forms, and portals. Users are then directed to either login, fill out a form, or confirm their identity for verification on their DSAR. User Receives Data from DSAR, 203: Users will be sent data from the company or companies they have requested data from. The data they have requested will come within minutes from most companies. However, companies legally have to send users their Personally Identifiable Information (PII) within 30 to 45 days depending on their legal jurisdiction and the number of users. Data is typically sent in JSON, HTML, pdf, CSV, excel, and .zip files. Users can download their PII to their desktop or mobile device.

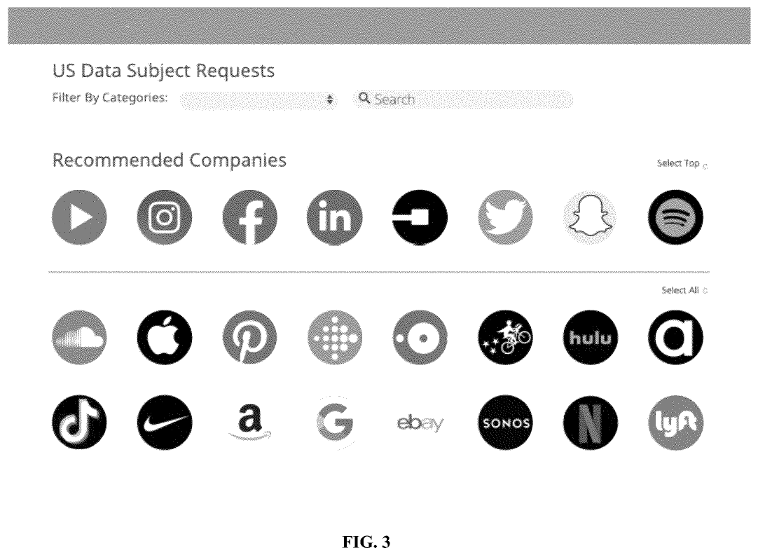

Now referring to FIG. 3: Data Subject Request Dashboard w/Recommendations Algorithm. This is our expanded version of UDSRD. Users can search companies they want to request data from and filter companies by different categories—social media, shopping, ride-sharing, music, payments, etc. Users will also be recommended companies to request data from via our off-app digital footprint identifier. Based on previous uploads our algorithms can figure out where else their digital footprint has been located and is then recommended to the user. Users also are able to opt out and delete their data from unwanted companies. On this dashboard, users have the ability to manage their DSAR.

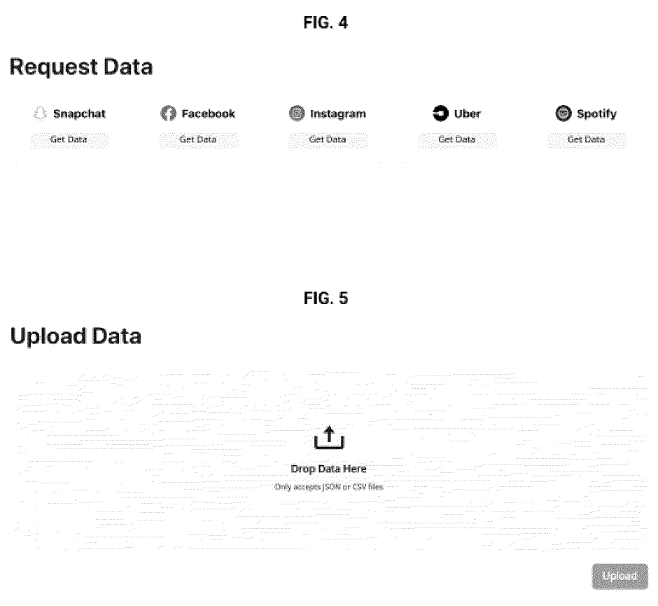

Now referring to FIG. 4: Current Data Subject Request Dashboard. This is an illustration of DataEarn's current UDSRD. Users can request data from these five companies and be taken directly to the company's Subject Data Request Portal.

Now referring to FIG. 5: User Uploads Data from Company. Shows how users can drag and drop or select files from their computer that have been received from their DSAR. This upload page allows users the ability to easily upload their PII.

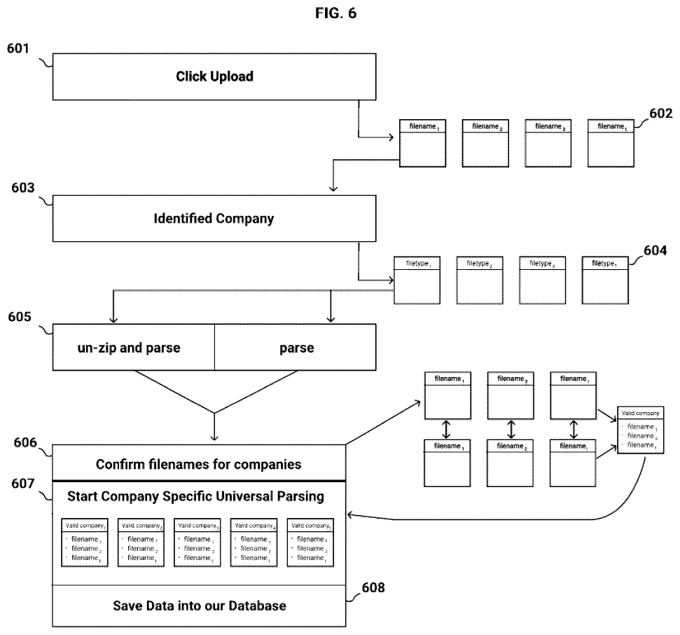

Now referring to FIG. 6: Universal parser method is illustrated. This Universal Parser method allows us to add any company into our system and set up a framework that can correctly identify companies, parse through company-specific data, and store data in our database. 601: The user clicks the upload button. 602: Once the button upload is hit, our Universal Parser reads through the file names for the company data set uploaded, using the methods described herein using, for example, code such as described by the following pseudo code:

```
def parsingData(request):
  files = [ ]
  for i in ′.json′:
    filename = i.name
    files.append(filename)
  for i in ′.csv′):
    filename = i.name
    files.append(filename)
  for i in ′.html′:
    filename = i.name
    files.append(filename)
  for i in ′.zip′:
    filename = i.name
    files.append(filename)
```

603: Our Universal Parser identifies certain file names and data structures within the upload to identify what company the data came from. If the filename is ‘user data’ and is equal to company X. We will match that file ‘user data’ with company X. If the filename is ‘data_lake’ and correlated to company Y. We will match those files with company Y. If a user uploads ‘profile information’ and if the filename is the same across multiple companies our Universal Parser will read into the data structure and parse through it to determine further which company it came from. For each company, the data structure and output of code will be different, and then our Universal Parser can then dictate with validity which company it came from.
company_x=‘companyXdata.json’
company_y=‘companyYdata.csv’
company_t=‘companyTdata.zip’

604: Once the company is identified, our system reads what type of file type the code is. Our universal parser will look for endings—.zip, JSON, CSV, HTML, pdf, jpeg, .xlm, etc. Once identified it will then get confirmed and sent to the right function to get parsed.

605: Our Universal Parser will either unzip the file uploaded and then parse the upload or parse the upload depending on the user company upload type.

```
if set(company_x).issubset(set(files)):
  if_zip:
    companyXParser = ParseX(content, is_zip=True)
  else:
    companyXParser = ParseX(request)
elif set(company_y).issubset(set(files)):
  if_zip:
    companyYParser = ParseY(content, is_zip=True)
  else:
    companyYParser = ParseY(request)
elif set(company_t).issubset(set(files)):
  if_zip:
    companyTParser = ParseT(content, is_zip=True)
  else:
    companyTParser = ParseT(request)
else:
  return None
```

606: Our Universal Parser will then identify all the files that are uploaded and cross-reference our internal filename system to confirm that the files match the company-specific filenames. If the filename equals our internal records of the filename, our parsers will execute and parse the file.

```
def companyXParse:
  if fn == ″companyXfile.json″:
    fd =json.loads(val.read( ))
    self.companyXfile(fd)
  elif fn == ″companyXfile2.json″:
    fd = json.loads(val.read( ))
    self.companyXfile2(fd)
def companyYParser:
  if fn == ″companyYfile.json″:
    fd = json.loads(val.read( ))
    self.companyYfile(fd)
  elif fn == ″companyYfile2.json″:
    fd =json.loads(val.read( ))
    self.companyYfile2(fd)
def companyTParser:
  if fn == ″companyTfile.json″:
    fd =json.loads(val.read( ))
    self.companyTfile(fd)
  elif fn == ″companyTfile2.json″:
    fd = json.loads(val.read( ))
    self.companyTfile2(fd)
```

607: If the upload matches our internal naming system, our Universal Parser will then loop through all of the filenames. Depending on the filename and structure within the file, our Universal Parser will read the filename and then parse through the unique data structures on a file-by-file basis. Each file has a different data structure that our parsers are set up to read through.

```
def companyXfile(fd):
  table = [ ]
  for i in fd[′key_value′]:
    table.append(i[′value′])
def companyXfile2(fd):
  table = [ ]
  for i in fd[′key_value′]:
    table.append(i[′value′])
def companyYfile(fd):
  table = [ ]
  for i in fd[′key_value′]:
    table.append(i[′value′])
def companyYfile2(fd):
  table = [ ]
  for i in fd[′key_value′]:
    table.append(i[′value′])
def companyTfile(fd):
  table = [ ]
  for i in fd[′key_value′]:
    table.append(i[′value′])
def companyTfile2(fd):
  table = [ ]
  for i in fd[′key_value′]:
    table.append(i[′value′])
```

608: The data parsed data from each file will then be sent and saved in our database.

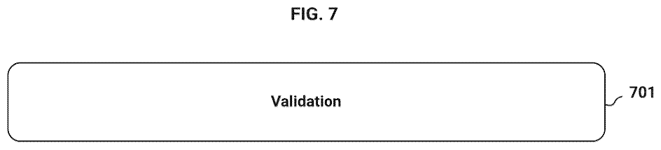

Now referring to FIG. 7: Validation, 701: Once the user has uploaded their data and our algorithms have parsed through the data, there are a variety of ways the system validates the validity of the data. We can validate the data through metadata, timestamps of requests and uploads, data within the file, and edit history. When a user registers with DataEarn, the system will cross-validate the information the user has submitted with a multitude of PII variables that have been uploaded from their company-specific uploads. The more companies that the user uploads, the more ways we can validate the validity of the data and the better our validation of the data becomes. The system evaluates and analyses timestamps, and verifies data points from other companies' internal systems (devices, location, activity on certain apps, bank history, etc). In this system, we can also analyze the file's metadata and see if there were any previous edits or when it was downloaded to their desktop. Any edits to the file will lower the validity of the file and won't be allowed for sale. When users click “Get Data” we also reference the time in which they click that button to when the file was created to validate the authenticity of the file. These metrics help us identify how valid the user data is.

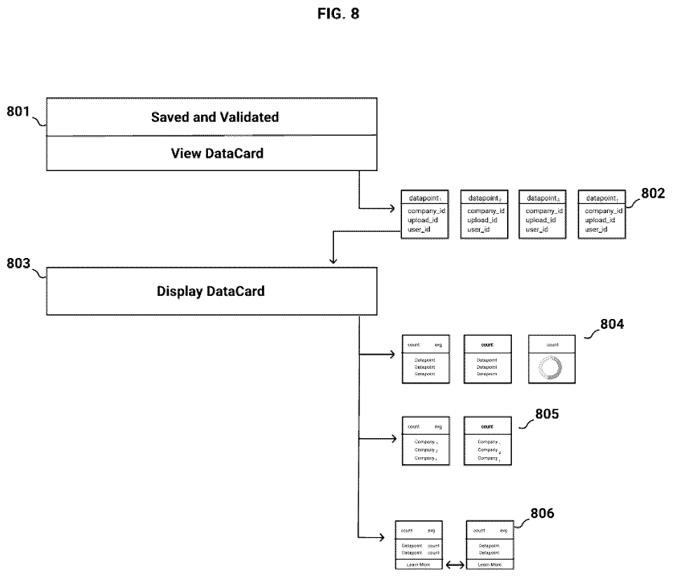

Now referring to FIG. 8: Workflow of Displaying DataCards from Companies, 801: Once the data is saved and validated in our system, the data is ready to be displayed. The files and data are set up and normalized via our Universal Parser which allows users to see the data in a readable and understandable format. 802: When users go to view their uploaded data, our queries execute functions from our database that calls the company_id, upload_id, and user id. These 3 types of identifiers are linked to the user's data points parsed by our Universal Parser. This allows the user to be able to view their own data from each company and each upload. 803: Once the company_id, upload_id, and user id are validated, our system queries the unique datapoints parsed in the Universal Parser and starts to create a personalized dashboard display for the user on a company by company basis. 804: Within these queries, there are many types of analysis and queries that are performed to display the data in a readable and understandable format that we can show to the user (i.e—Count, Most Recent, Most Action, Time Averages, and more). Our Universal Parsers allow us to perform any type of query or analysis on the data. 805: Users can also view a variety of categories across different companies that the user has uploaded. Once a user uploads data from multiple companies the system can query certain categories of data (off-app activity, location, spending, search, saves, likes, etc.) across all companies to show the user their DataEarn Card. The system can show the history of the user's PII and all the data they have produced online across every company the user has ever uploaded onto our website and see a complete digital profile of oneself. For example, if a user searched something on Snapchat and Facebook the system can show the complete history of their searches ordered by their timestamps in a DataEarn Search Card. 806: Users can then view, scroll and click through the DataCards.

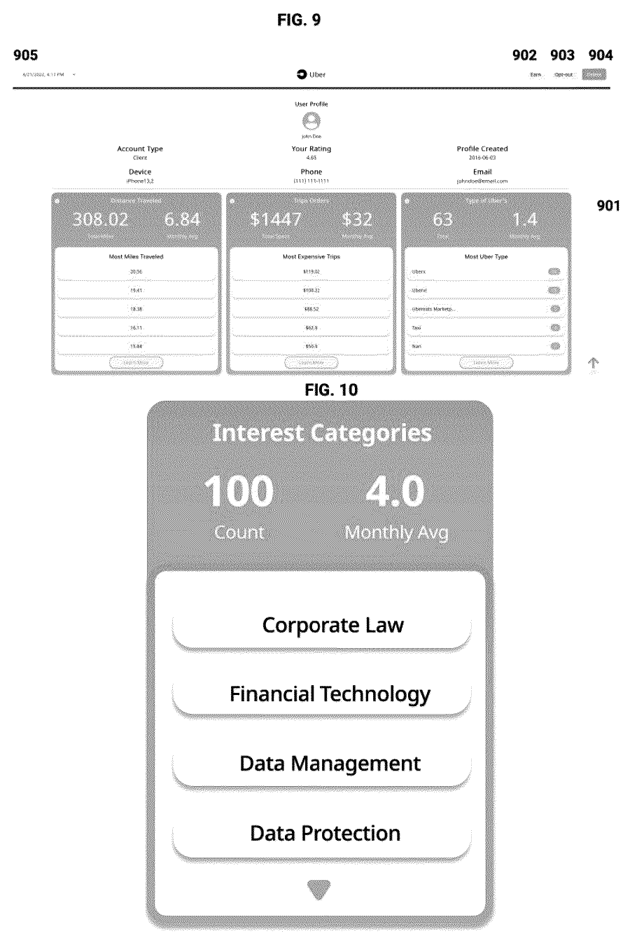

Now referring to FIG. 9: Display DataCards for Individual Companies, 901: This is an example of DataCard summarizing users' data from a rideshare company. After our systems successfully parsed through the data uploaded by the user, the system can query the users' data in our database and then see their data from the specific companies they've uploaded from. Users can see their data in the form of a DataCard. The algorithms behind the DataCards query and format the data so users can easily understand it. For certain variables, we calculate the count, yearly to daily averages, most occurrences of a certain type of action (likes, views, searches, posts, etc), and most recent data that is organized by timestamp. DataCards allow people to have their own customizable dashboard that shows all the PII that has been created from their DSAR in an easily accessible and readable format. For Opt-in or “Earn” to DataStore, 902: Users can click this button that will link them to a company's Opt-In DataStore Page. Once their data is validated, users can then set their preferred price of sale on the data points from the desired company and DataCard. For Opt-out of Sale of Data, 903: Users can click this button that links them to a specific company's Opt-Out of Sale Page. Users can then opt-out of the sale of their data. To Delete Data, 904: Users can click this button that will link them to a company's Delete Data Page on a company's website. Users can then delete their data from the desired company. For Versioning, 905: Users can click this button that will allow them to view the current and previous versions that they have uploaded.

Now referring to FIG. 10: Display DataCards for Individual Companies, this shows an example of an individual DataCard that shows a user their data. The DataCard identifies how many interest categories are targeted towards a user, the monthly average of when these categories are updated to their account, and the most recent interest categories that were uploaded for that individual. There are many different types of variations these DataCard follow. This is the way the DataCard is formatted and organized.

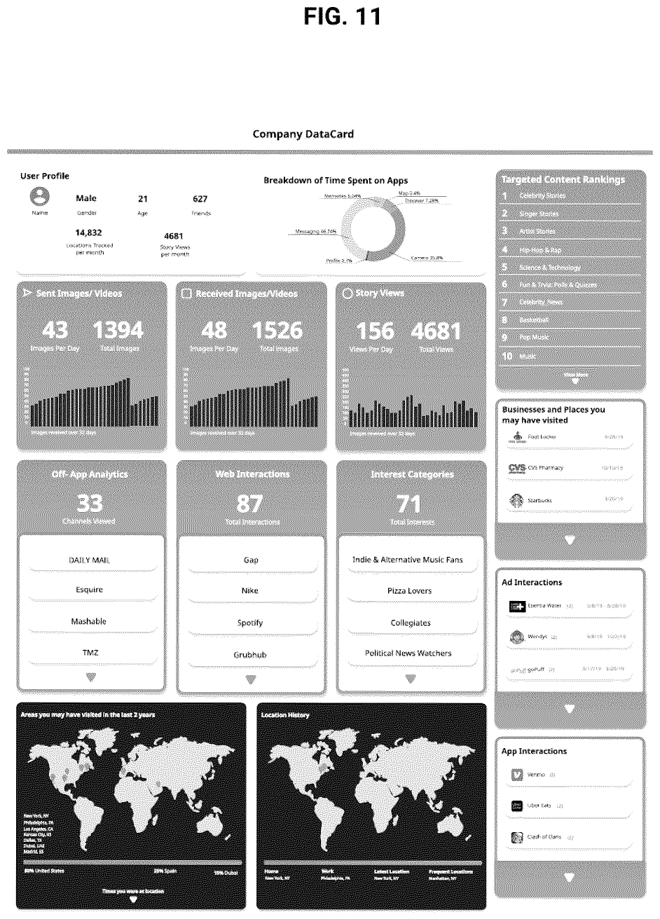

Now referring to FIG. 11: Display DataCards for Individual Companies, this is an example of a complete DataCard for an Individual Company. After our systems successfully parsed through the data uploaded by the user, the system can query the users' data in our database and then see their data from the specific companies they've uploaded from. Users can see their data in the form of a DataCard. The algorithms behind the DataCards query and format the data so users can easily understand it. For certain variables, we calculate the count, yearly to daily averages, most occurrences of a certain type of action (likes, views, searches, posts, etc), and most recent data that is organized by timestamp. DataCards allow people to have their own customizable dashboard that shows all the PII that has been created from their DSAR in an easily accessible and readable format.

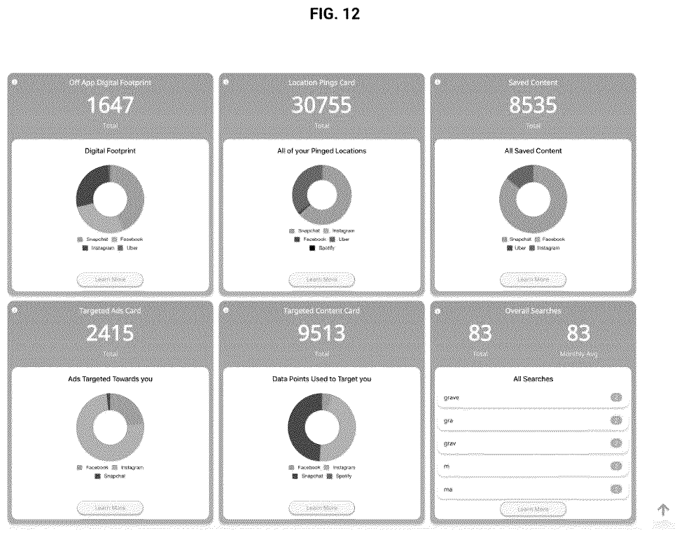

Now referring to FIG. 12: Displaying DataEarn DataCard, in this diagram, the data is from a variety of companies that the user has uploaded. Once a user uploads data from multiple companies the system can query certain categories of data (off-app activity, location, search, saves, likes, etc) across all companies to show the user their DataEarn Card. The system can show the history of the user's PII and all the data they have produced online across every company the user has ever uploaded onto our website and see a complete digital profile of oneself. For example, if a user searched something on Snapchat and Facebook the system can show the complete history of their searches ordered by their timestamps in a DataEarn Search Card.

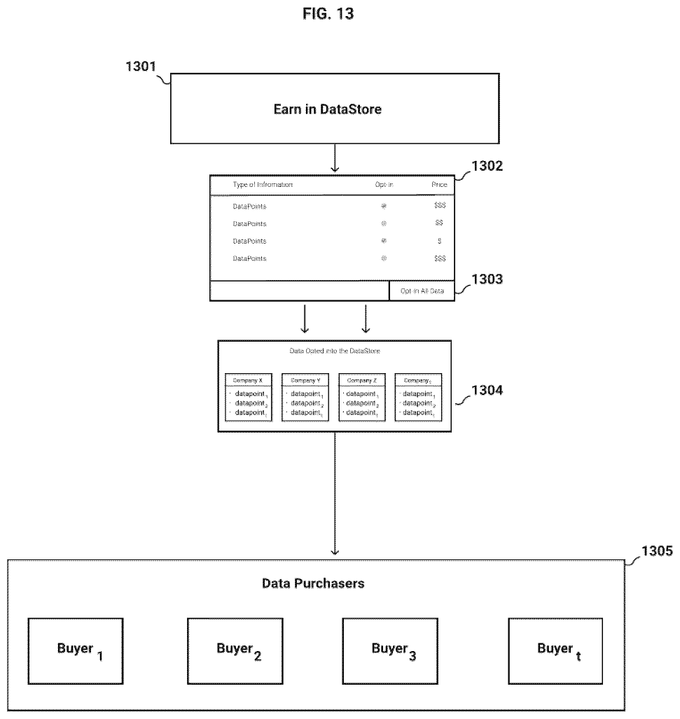

Now referring to FIG. 13: Opt-in to DataStore, 1301: Users can click the “Earn” button that takes them to a page that allows them to select what type of data they want to opt-in to sell, transfer, or exchange. 1302: Users can select the data points they want to opt-in to the DataStore. Users can also set the price point of how much they want to sell those data points. 1303: Users can also Opt-in all of their data at once. 1304: Once their data is opt-ed into DataStore, the user can have full transparency of where the data is going and how much it is being sold for. 1305: Once you are opt-ed into the DataStore, you can decide to share your data with one or more third parties who will pay you for the right to use your data in ways you permit. In exchange, each buyer will make payments to DataEarn, from which DataEarn will retain a percentage and pass along the remainder of the payment. By submitting data into the DataStore, users can view where their data is going and its value.

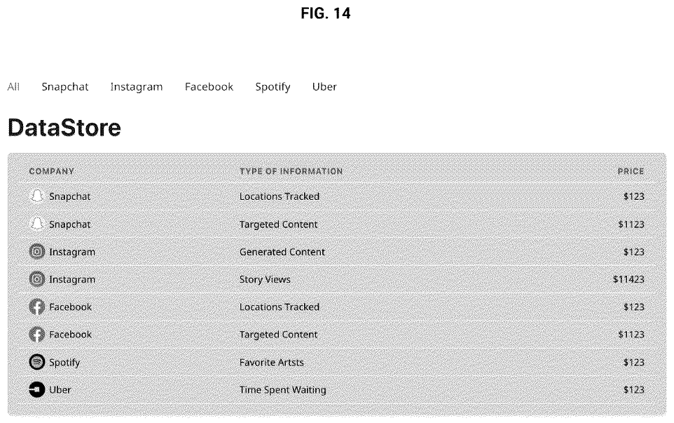

Now referring to FIG. 14: DataStore, this diagram illustrates what information users have opt-ed into the DataStore. Users on our platform can opt-in specific datasets into our DataStore. Users can choose what company they want to add, the specific DataCard, and the price at which they want to sell it. Once a user has opted-in their data into the DataStore, they are allowing companies to browse individuals' information.

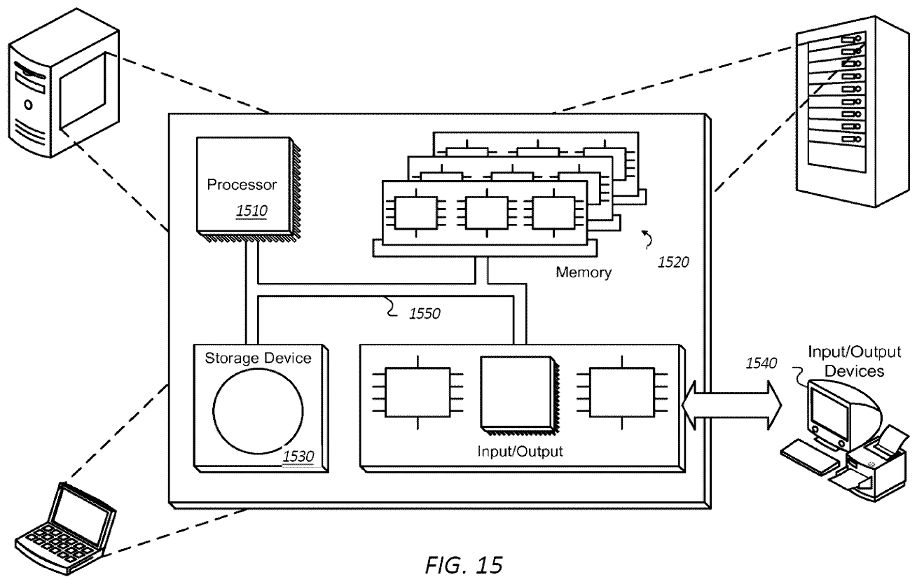

FIG. 15 is a schematic diagram of a generic computer system 1500. The system 1500 can be used for practicing operations described, for example in association with the methods described herein. The system 1500 can include a processor 1510, a memory 1520, a storage device 1530, and input/output devices 1540. Each of the components 1510, 1520, 1530, and 1540 are interconnected using a system bus 1580. The processor 1510 is capable of processing instructions for execution within the system 1500. In one implementation, the processor 1510 is a single-threaded processor. In another implementation, the processor 1510 is a multi-threaded processor. The processor 1510 is capable of processing instructions stored in the memory 1520 or on the storage device 1530 to display graphical information for a user interface on the input/output device 1540.

The memory 1520 is a computer readable medium such as volatile or non-volatile that stores information within the system 1500. The storage device 1530 is capable of providing persistent storage for the system 1500. The storage device 1530 may be a floppy disk device, a hard disk device, an optical disk device, or a tape device, or other suitable persistent storage means. The input/output device 1540 provides input/output operations for the system 1500. In one implementation, the input/output device 1540 includes a keyboard and/or pointing device. In another implementation, the input/output device 1540 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A computer-implemented method executed by one or more processors for obtaining and viewing user data, the method comprising:
sending, to a system and by a user, a data set comprising personally identifiable information and a plurality of platforms;
determining, by the system, characteristics of each platform in the plurality of platforms;
parsing, by the system, the data set based on the characteristics of each platform;
generating, by the system, a DataCard comprising a digital footprint of a user for each platform;
displaying, to the user, the DataCard; and
querying the user to interact with the DataCard.

2. The method of claim 1, wherein the querying a user to interact with the DataCard comprises at least one of:
opt-out of selling the digital footprint;
opt-in to selling the digital footprint;
selling the digital footprint; and
view more detail about the digital footprint.

3. The method of claim 1, wherein the digital footprint of a user for each platform comprises at least one of:
user statistics;
location history;
advertisement history;
purchase history;
network information; and
user activity.

4. The method of claim 1, wherein the characteristics of each platform of the plurality of platforms comprises at least one of:
file names;
data structures; and
files types.

5. A system for obtaining and viewing user data, the system comprising a memory storing processor executable instructions and one or more processors to:
send, to a system and by a user, a data set comprising personally identifiable information and a plurality of platforms;
determine, by the system, characteristics of each platform in the plurality of platforms;
parse, by the system, the data set based on the characteristics of each platform;
generate, by the system, a DataCard comprising a digital footprint of a user for each platform;
display, to the user, the DataCard; and
query the user to interact with the DataCard.

6. A system for allowing a user of any company to upload their data into a system that can parse and reverse engineer companies' data into a personal dashboard for the user.
